(19) United States
(12) Patent Application Publication
(10) Pub. No.: US 2011/0154256 A1
(43) Pub. Date: Jun. 23, 2011

(54) ELECTRONIC APPARATUS AND METHOD OF CONTROLLING THE SAME

(75) Inventor: Yong-beom BAHG, Gyeonggi-do (KR)

(73) Assignee: SAMSUNG ELECTRONICS CO., LTD., Gyeonggi-Do (KR)

(21) Appl. No.: 12/829,499

(22) Filed: Jul. 2, 2010

(30) Foreign Application Priority Data
Dec. 17, 2009 (KR) 10-2009-0126280

(51) Int. Cl. G06F 3/048

(52) U.S. Cl. 715/810

(57) ABSTRACT

An electronic apparatus and method of controlling the same that permits easier scrolling of files and directories. The electronic apparatus preferably includes: a display; a storage unit storing a plurality of files classified by directories; an input unit receiving input from a user; and a controller controlling the display to display a selected first directory and content of the first directory and to display at least one second directory other than the first directory corresponding to exploration in a direction by the input from the user.

### CLAIM OF PRIORITY

This application claims the benefit of priority from Korean Patent Application No. 10-2009-0126280, filed on Dec. 17, 2009 in the Korean Intellectual Property Office, the disclosure of which is incorporated herein by reference in its entirety.

### BACKGROUND OF THE INVENTION

1. Field of the Invention

The present invention relates to an electronic apparatus and a method of controlling the same. More particularly, the present invention relates to searching higher or lower directories of a current.

2. Description of the Related Art

In recent years, as the memory capacity of an electronic apparatus continues to increase, the electronic apparatus can store an ever larger number of files. The more files the electronic apparatus stores, the more time and effort a user spends in searching for a file. Therefore, the electronic apparatus generally sorts and stores files in directories in order that a user may efficiently search for a file.

A directory also refers to a folder, and a large number of directories are hierarchically connected to form a tree structure. A plurality of related files are arranged and stored in the same directory. A directory may belong to a higher-level directory than its own level. Likewise, one directory may include a plurality of subdirectories in a lower level than its own level.

FIG. 1 illustrates an operation of a general electronic apparatus exploring a file.

In order to search a specific file, a user needs to browse directories in a hierarchical structure in order to explore a directory which the specific file belongs to.

When browsing directories, the electronic apparatus typically displays content of a directory currently being explored on a screen 100. In more detail, the electronic apparatus may display subdirectories and files which belong to the directory currently being explored. With reference to FIG. 1, a plurality of subdirectories which belong to the directory (folder) currently being explored are displayed in the form of icons on the screen 100.

If exploring higher or lower directories of the directory currently displayed on the screen 100, the user travels to a directory using a transfer button 110 to a higher directory or a transfer button 120 to a lower directory. In this case, the content of a directory to which the user has been transferred is displayed on the screen.

In this manner, when exploring a directory by a related art, only the content of a directory currently being explored is displayed. Thus, the user has difficulty recognizing at a glance the current directory and higher or lower directories of the current directory.

### SUMMARY OF THE INVENTION

Accordingly, the present invention provides a file exploring function that enables browsing of a higher or lower directory of a current directory and a quick transfer to a higher or lower directory of a current directory unknown heretofore.

The foregoing and/or other exemplary aspects of the present invention may be achieved by providing an electronic apparatus that preferably includes: a display processing and displaying an image; a storage unit storing a plurality of files classified by directories; a user input unit receiving input from a user; and a controller controlling the display to display a selected first directory and content of the first directory and to display at least one second directory other than the first directory corresponding to exploration in a direction by the input from the user.

The second directory, for example, may be in the same directory level as the first directory or in a different directory level from the first directory.

The exploration in the direction may include exploration to a higher directory level of the first directory, exploration to a lower directory level of the first directory and/or exploration in a directory level of the first directory.

The controller, for example, may control the display of a first indicator representing a directory level of the first directory.

The controller, for example, may control the display of a directory level of the second directory in the first indicator.

The controller, for example, may control the display of second indicator corresponding to the exploration in the direction.

The controller, for example, may control the display of a third indicator corresponding to a transfer to a directory level.

The content of the first directory, for example, may include at least one of a lower directory of the first directory and files included in the first directory.

The controller, for example, may control the display of an icon corresponding to the first directory and an icon corresponding to the second directory.

The input from the user may include, for example, at least one of a slide input, touch input and input via a button.

Another exemplary aspect of the present invention may be achieved by providing a method of controlling an electronic apparatus including: sorting and storing a plurality of files by directories; receiving input from a user; displaying a selected first directory and content of the first directory; and displaying at least one second directory other than the first directory corresponding to exploration in a direction by the input from the user.

The second directory, for example, may be in the same directory level as the first directory or in a different directory level from the first directory.

The exploration in the direction may preferably include exploration to a higher directory level of the first directory, exploration to a lower directory level of the first directory and exploration in a directory level of the first directory.

The inventive method may further include displaying a first indicator representing a directory level of the first directory.

The inventive method may further include displaying a directory level of the second directory in the first indicator.

The inventive method may further include displaying a second indicator corresponding to the exploration in the direction.

The inventive method may further include displaying a third indicator corresponding to a transfer to a directory level.

The content of the first directory may include, for example, at least one of a lower directory of the first directory and files included in the first directory.

The inventive method may further include displaying an icon corresponding to the first directory and an icon corresponding to the second directory.

The input from the user may preferably include at least one of slide input, touch input and input via a button.

### BRIEF DESCRIPTION OF THE DRAWINGS

The above and/or other exemplary aspects will become apparent and more readily appreciated by a person of ordinary skill in the art from the following description of the exemplary embodiments, taken in conjunction with the accompanying drawings, in which:

FIG. 1 illustrates an operation of a general electronic apparatus exploring a file.

FIG. 2 is a block diagram illustrating a configuration of an electronic apparatus according to one exemplary embodiment of the present invention.

FIG. 3 illustrates a window for exploring a file according to one exemplary embodiment of the present invention.

FIGS. 4A and 4B illustrate a window for exploring a file according to another exemplary embodiment of the present invention.

FIGS. 5A and 5B illustrate a window for exploring a file according to still another exemplary embodiment of the present invention.

FIG. 6 illustrates a method of controlling an electronic apparatus according to one exemplary embodiment of the present invention.

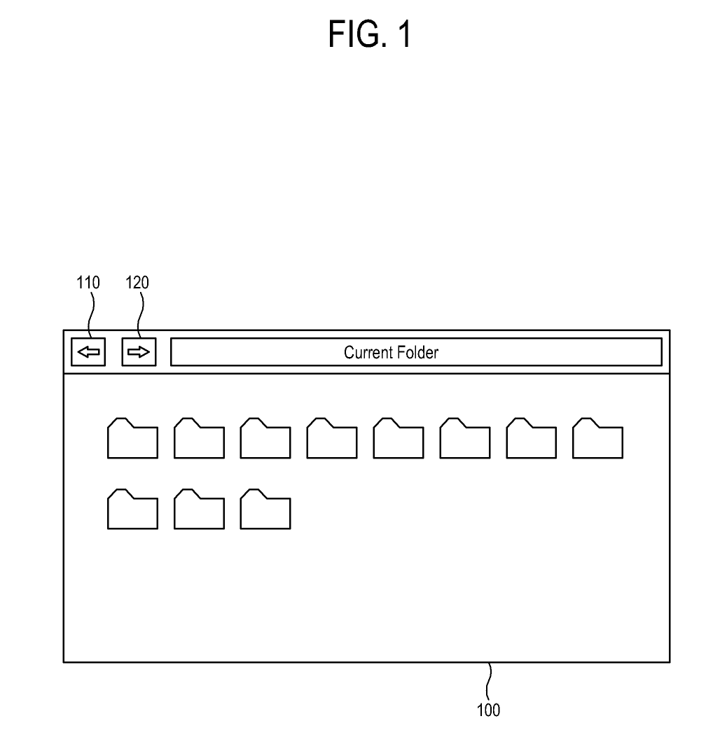

### DETAILED DESCRIPTION

Below, exemplary embodiments will be described in detail with reference to accompanying drawings so as to be easily realized by a person having ordinary skill in the art. The exemplary embodiments may be embodied in various forms without being limited to the exemplary embodiments set forth herein. Descriptions of well-known parts may be omitted for clarity when their inclusion might obscure appreciation of the subject matter of the present invention, and like reference numerals typically refer to like elements throughout the disclosure.

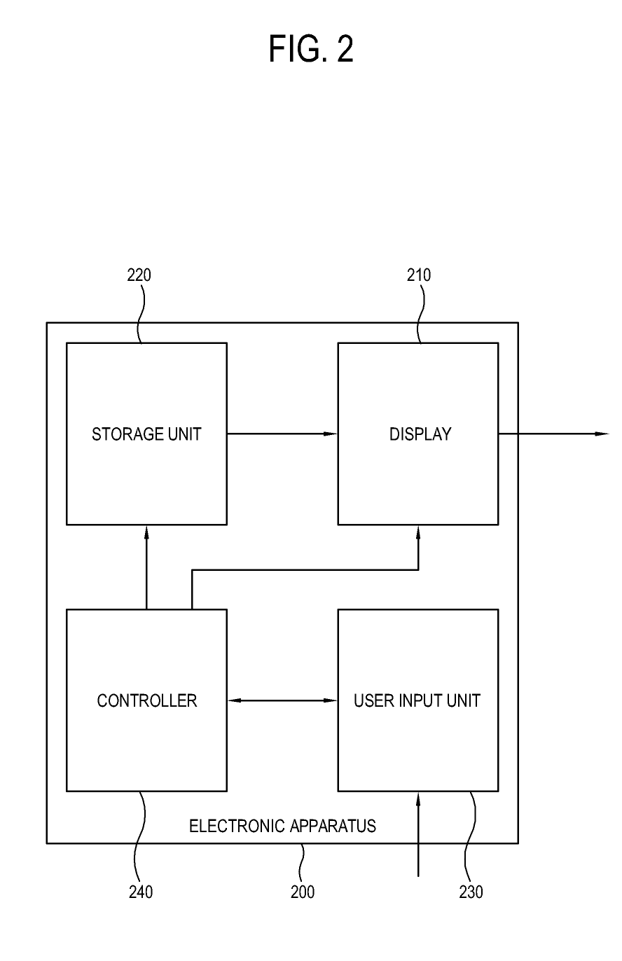

FIG. 2 is a block diagram illustrating a configuration of an electronic apparatus according to one exemplary embodiment of the present invention.

Now referring to FIG. 2, the electronic apparatus 200 may comprise a mobile terminal, a laptop computer, a personal digital assistant (PDA), an MP3 (MPEG Audio Layer-3), a desktop computer, a digital TV, etc., just to name a few of the many possibilities to which the presently claimed invention is applicable. Further, the electronic apparatus 200 according to the exemplary embodiment of the present invention may include any electronic device as long as it sorts and stores a plurality of files in directories and explores stored files and directories.

The electronic apparatus 200 according to the exemplary embodiment of the present invention preferably includes a display 210, a storage unit 220, a user input unit 230 and a controller 240.

The display 210 processes and displays an image. More specifically, the display 210 displays a first directory and a second directory. In this case, the display 210 displays icons corresponding to the first directory and the second directory, respectively. The first directory is a selected directory. The second directory is a different directory from the first directory. The second directory is in the same level (e.g. same level in a hierarchy) as the first directory, or can be in a different level.

Furthermore, the display 210 displays content of the first directory. In this particular case, the content of the first directory may comprise at least one of a subdirectory of the first directory and files in the first directory. A subdirectory and a file may be displayed in icons and/or letters, respectively. It is also possible to show the subdirectory and files in many other ways, for example, as thumbnails.

Meanwhile, the display 210 may include a display panel (not shown) that may comprise a liquid crystal display (LCD), an organic light emitting display (OLED) or a plasma display panel (PDP), and a panel driver, or any other type of thin film technology display.

The storage unit 220 stores a plurality of files classified by directories. To this end, the storage unit 220 may include both a volatile memory and a nonvolatile memory. The volatile memory may be realized as a static random access memory (SRAM), a dynamic random access memory (DRAM), etc. The nonvolatile memory may be provided as a read only memory (ROM), a flash memory, a hard disk, etc.

The user input unit 230 receives a user's input. Specifically, user's input includes at least one of slide input, touch input and input via a button. In this case, the user input unit 230 may receive input from a user through a touch panel or a touch screen of the electronic apparatus 200, an input device such as a mouse, a key button, etc.

The controller 240 controls the display of the first directory and the content of the first directory on display 210, and to display at least one second directory different from the first directory corresponding to exploration in a direction by user's input. In this case, exploration in a direction may include at least one of exploration of a directory in a higher level than the first directory, exploration of a directory in a lower level than the first directory, and exploration of a directory in the same level as the first directory.

According to an exemplary embodiment of the present invention, the controller 240 controls the display of a first indicator representing a directory level of the first directory by display 210. Specifically, the first indicator may be displayed as a number of images corresponding to the directory level of the first directory. For example, the first indicator may be displayed as a number of circles corresponding to the directory level of the first directory. The first indicator makes it easier to recognize a relative position of the first directory.

With regard to the display of the first indicator, the controller 240 controls the display 210 to display a directory level of at least one second directory in the first indicator. Specifically, the display 210 may display an image corresponding to a directory level of at least one second directory among a plurality of images distinguishingly from other images.

Alternatively, the controller 240 controls the display 210 in order to display a second indicator corresponding to exploration in a direction. In this case, a user can explore directories in a given direction or directions from a currently selected directory. Specifically, the user explores a higher directory or a lower directory of the currently selected directory by using a directory scrolling function. If the user selects a directory other than the current directory, the selected directory becomes a current directory and content is changed in accordance with the current directory. If the selects a file rather than a directory, the directory in which the file is located becomes a current directory and content is changed in accordance with the current directory.

According to another exemplary embodiment, the controller 240 controls the display of a third indicator corresponding to a transfer to a directory level.

Meanwhile, while the display 210 displaying the first directory and the second directory, the controller 240 controls the display of an icon corresponding to the first directory and an icon corresponding to the second directory.

If the display 210 shows the content of the first directory, the controller 240 controls the display of display icons and/or letters corresponding to a subdirectory of the first directory and/or a file included in the first directory.

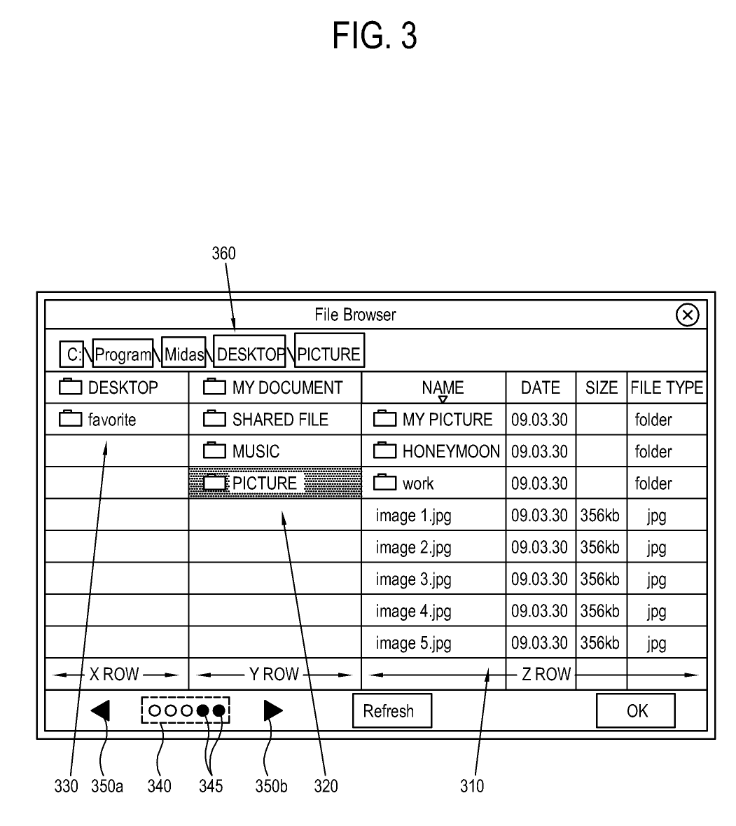

FIG. 3 illustrates a screen shot for exploring a file according to another exemplary embodiment of the present invention.

If a user explores directories in a direction in which a first directory selected, at least one second directory other than the first directory may be displayed corresponding to the exploration in the direction.

If a user selects a picture folder, then the picture folder becomes the first directory. In this case, all other folders than the picture folder are a second directory. Specifically, a “my document” folder, a “shared file” folder and a “music” folder are in the same level as the picture folder. Further, a “desktop” folder and a “favorite” folder are in a higher level than the picture folder. A “my picture” folder, a “honeymoon” folder and a “work” folder are subfolders of the picture folder, which are in a lower level than the picture folder.

Content of the first directory 310 is displayed in a Z row. Referring to FIG. 3, content of the picture folder is displayed in icons and letters in the Z row. In detail, the subfolders of the picture folder, i.e., my picture subfolder, honeymoon and work subfolders, are displayed in icons. Further, files in the picture folder, i.e., image 1.jpg, image 2.jpg, image 3.jpg, image 4.jpg, and image 5.jpg, are displayed in file names.

The first directory and a second directory in the same directory level as the first directory 320 are displayed in a Y row. With reference to FIG. 3, the “picture” folder, and the “my document” folder, the “shared file” folder and the “music” folder which are all in the same directory level as the picture folder are displayed in icons in the Y row.

Referring again to FIG. 3, a second directory, which is in a different directory level from the first directory 330, is displayed in an X row. For example, a desktop folder and a favorite folder are displayed in icons, respectively, in the X row.

A first indicator 340 is displayed preferably in a lower area of the file exploring window. In more detail, the first indicator 340 is displayed in a number of circles corresponding to a directory level of the picture folder. In this case, the directory level may be displayed in an image with reference to a path to the picture folder. The path to the picture folder is C:\program\Midas\desktop\picture. A “C:” folder is in a first directory level, a “program” folder is in a second directory level, a “Midas” folder is in a third directory level, the “desktop” folder is in a fourth directory level, and the “picture” folder is in a fifth directory level. That is, since the picture folder is included in the fifth directory level, as shown in FIG. 3, the first indicator 340 is formed of five circles. In this case, a user can easily recognize the directory level of the picture folder currently selected from the number of circles included in the first indicator 340.

Second indicators 350a, 350b are preferably displayed in the lower area of the file exploring window. The user scrolls the second indicators 350a, 350b to carry out exploration to one of a higher directory level and/or a lower directory level of the picture folder. As shown in FIG. 3, the fourth directory level and the fifth directory are explored corresponding to user's exploration.

In this particular embodiment of the present invention, a directory level of the second directory, currently being explored, may be displayed in the first indicator 340. The directory levels currently being explored is the fourth directory level and the fifth directory level. Thus, a fourth circle and a fifth circle are expressed distinguishingly (in this case, darkened) from the other circles in the first indicator 340 to represent the directory levels currently being explored. A person of ordinary skill in the art understands and appreciates that the other visual indications (and indicators) can be used to distinguish the fourth and fifth circles in this particular example. There can be different colors displayed, flashing, increased or decreased size relates to the first through third circles, or the shape could be changed as well, just to name a few examples with the scope of the claimed invention. Meanwhile, with continued reference to FIG. 3, a third indicator 360 corresponding to a transfer to a directory level is displayed in the top of the file exploring window. The path to the picture folder, “C:\program\Midas\desktop\picture,” is displayed in the third indicator 360 in FIG. 3. When a directory is selected among the directories displayed in the path, the first directory may be directly transferred to a selected directory level.

If exploring directories having similar titles or a directory arranged in a higher directory level than a current directory level, it is rather difficult to recognize a location of a specific directory. If directories are displayed in a tree structure, the tree is entirely opened out to calculate a depth to a current directory. According to the present exemplary embodiment, the first indicator displayed in the file exploring window makes it easier than known heretofore to recognize a relative location of a current directory.

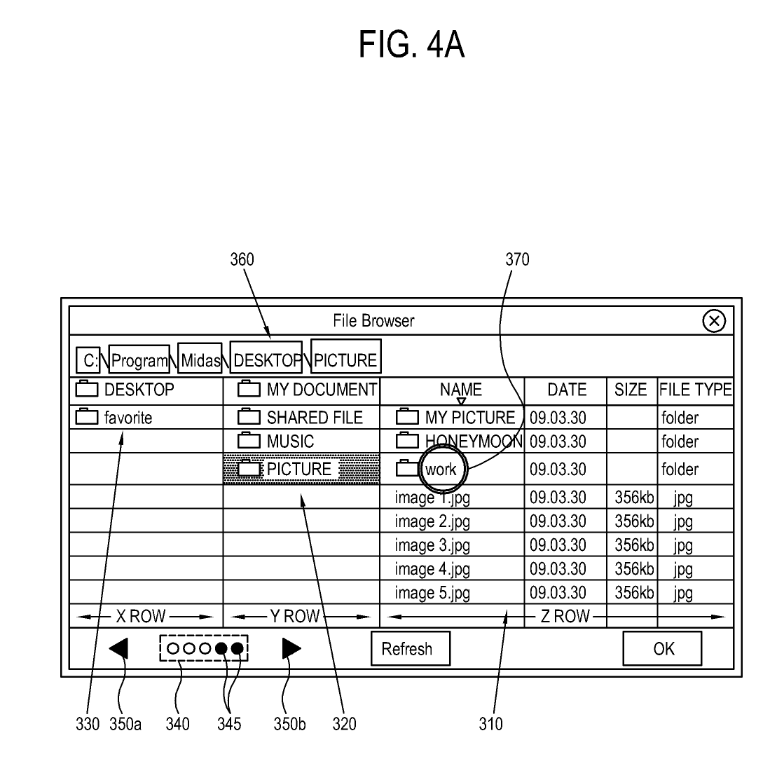

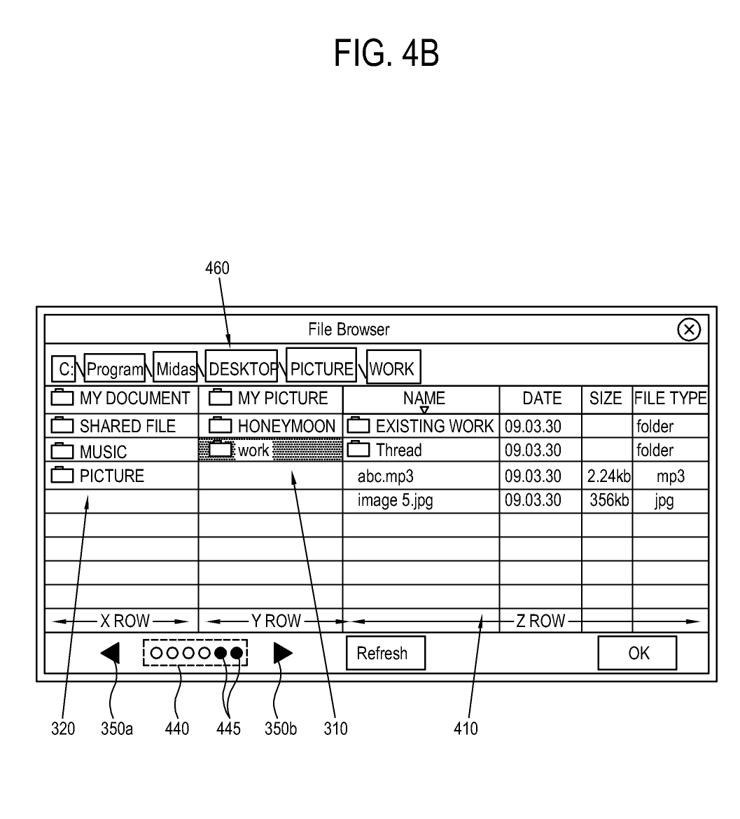

FIGS. 4A and 4B illustrate a window for exploring a file according to another exemplary embodiment of the present invention.

A user may transfer to a higher or lower directory of a first directory. In more detail, the user may select a higher or lower folder to transfer thereto. In FIG. 4A, if the user selects a work folder 370, he/she transfers to a lower folder of a picture folder, which is the work folder, which is shown in FIG. 4B.

When transferring to a lower folder, the content of the lower folder in a Z row 410. Namely, content of the work folder is displayed in icons and letters in the Z row. Specifically, FIG. 4B shows subfolders of the work folder, (i.e., “existing work” and “Thread”), are displayed in icons. Further, files included in the work folder, i.e., abc.mp3 and image 5.jpg, are displayed in file names.

Content which has been displayed in the Z row before a folder transfer is transferred to a Y row 310 and displayed. That is, a “my picture” folder, a “honeymoon” folder and a “work folder” are displayed in icons in the Y row 310. In this case, files other than the folders may be hidden. In FIG. 4A, files included in the picture folder, i.e., image 1.jpg, image 2.jpg, image 3.jpg, image 4.jpg and image 5.jpg, are not displayed in the Y row of FIG. 4B.

Comparing FIGS. 4A and 4B, content which has been displayed in the Y row before a folder transfer is transferred to an X row 320 and displayed. That is, a “my document” folder, a “shared file” folder a music folder and a picture folder are displayed in icons in the X row 320.

Meanwhile, content which has been displayed in the X row before a folder transfer (FIG. 4A) disappears by the folder transfer from the file exploring window. In other words, as shown in FIG. 4B, after the folder transfer, a desktop folder and a favorite folder are not displayed in the file exploring window.

Referring to FIG. 4B, a third indicator 460 which reports a path to a currently accessed folder is displayed in the top of the file exploring window. Since transferring to the lower folder of the picture folder, i.e., the work folder, “Work” is added to the folder path.

Namely, the path displayed in the third indicator 460 is changed from “C:\program\Midas\desktop\picture” to “C:\program\Midas\desktop\picture\work.” If a directory is selected among the directories displayed in the path, the first directory may be directly transferred to a selected directory level.

A first indicator 440 is changed in accordance with a directory level of a current folder. In FIG. 4B, the work folder is included in a sixth directory level. Thus, the first indicator 440 is changed to display six circles as shown in FIG. 4B, as opposed to five circles shown in FIG. 4A.

In FIGS. 4A and 4B, a fifth directory level and the sixth directory level are being explored according to user's exploration. Thus, a fifth circle and a sixth circle among the six circles are expressed distinguishingly from the other circles to represent the directory levels currently being explored. In FIG. 4B, the fifth and the sixth circles are expressed dark 445 from among the six circles in the first indicator.

Meanwhile, according to a modified exemplary embodiment, the user may transfer to a higher folder. In more detail, if the user selects a higher folder, transfers to the selected higher folder. In this case, content of the selected higher directory is displayed in the Z row. Higher directories of the directory displayed in the Z row may be displayed in the Y and X rows. Moreover, the first indicator is changed according to a directory level of the current folder, and a path to the current folder is also changed.

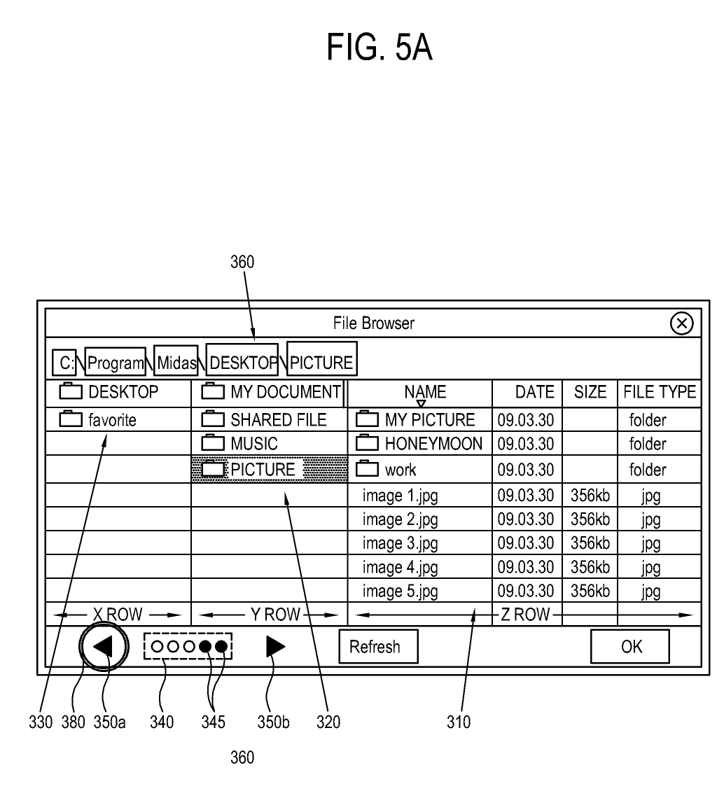

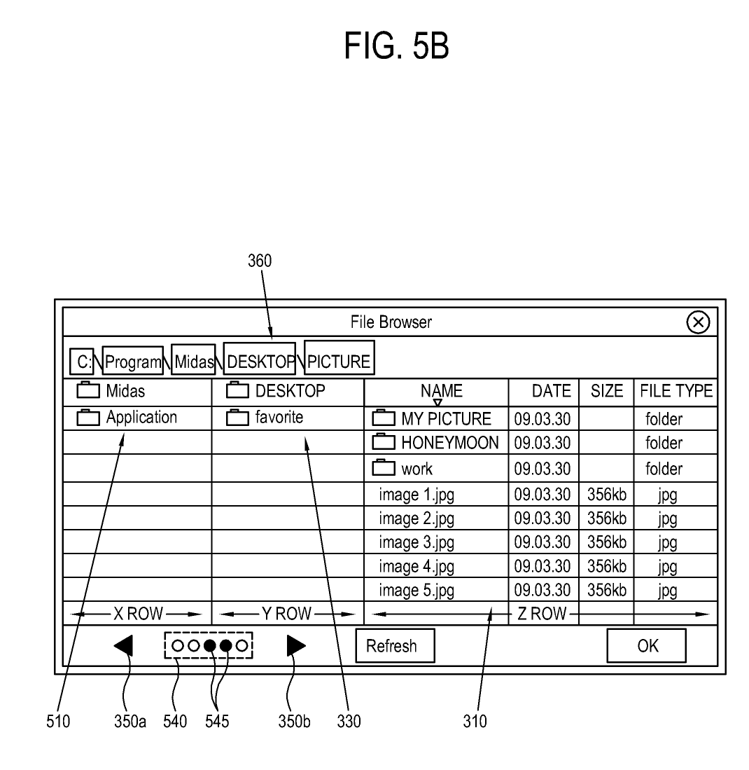

FIGS. 5A and 5B illustrate a window for exploring a file according to still another exemplary embodiment of the present invention.

A user may explore a higher directory level and a lower directory level of a directory with the directory selected.

In more detail, the user may explore a higher directory level and a lower directory level of a first directory using second indicators 350a and 350b shown in FIGS. 4A and 4B. In this particular case, the second indicators 350a and 350b may include a scroll button 350a displayed on a left side and a scroll button 350b displayed on a right side.

Since a new directory is not selected, a picture folder is kept selected. That is, if the user conducts an exploration to a higher directory level than current using the second indicators 350a and 350b, only content displayed in Y and X rows is changed while content displayed in a Z row 310 is maintained.

When selecting the scroll button 350a displayed on the left side, directories in higher directory levels are displayed in the Y and X rows, respectively.

In FIGS. 5A and 5B, directories in a fifth directory level are displayed in the Y row. Further, directories in a fourth directory level are displayed in the X row. In this state, when selecting the scroll button 350a displayed on the left side, the directories in the fourth directory level are displayed in the Y row. That is, as shown in FIG. 5B, a desktop folder and a favorite folder are now displayed in the Y row 330, as opposed to FIG. 5A when they were displayed in the X row. In addition, in FIG. 5B the directories in a third directory level are displayed in the X row. Namely, as shown in FIG. 5B, a Midas folder and an Application folder are displayed in the X row 510.

When selecting the scroll button 350b displayed on the right side, directories in lower directory levels are displayed in the Y and X rows, respectively.

When the user explores a higher directory level and/or a lower directory level of a first directory, an image indicating a depth of a folder from a folder currently being explored may be scrolled to the left or right. In FIGS. 5A and 5B, the third directory level and the fourth directory level are being explored corresponding to a user's exploration. Thus, as shown in FIG. 5B, a third circle and a fourth circle 545 are darkened among five circles.

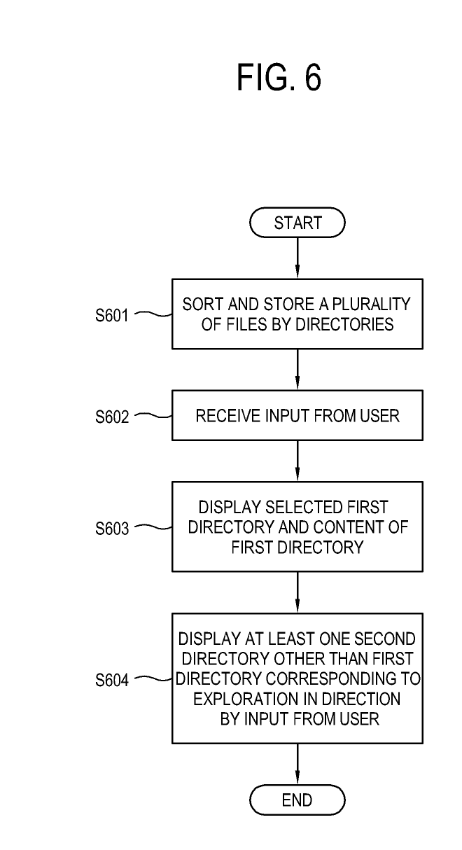

FIG. 6 is a flowchart illustrates exemplary operative steps of a method of controlling an electronic apparatus according to an exemplary embodiment of the present invention.

With reference now to FIG. 6, at (S601), an electronic apparatus 200 sorts and stores a plurality of files by directories.

At (S602), the electronic apparatus 200 receives input from a user.

At (S603), the electronic apparatus 200 displays a first directory selected and content of the first directory.

In this particular case shown in FIG. 6, the electronic apparatus 200 may display a first indicator representing a directory level of the first directory. Moreover, the electronic apparatus 200 may display a directory level of at least one second directory in the first indicator.

At (S604), the electronic apparatus 200 displays at least one second directory other than the first directory corresponding to exploration in a direction by input from the user.

According to the present exemplary embodiment, the user can quickly and conveniently explore a directory. In this case, the user can conveniently explore a higher directory or a lower directory of a currently selected directory while still viewing content of the currently selected directory.

As described above, the present invention provides a file exploring function which enables browsing of a higher or lower directory of a current directory and a quick transfer to a higher or lower directory of a current directory.

The above-described methods according to the present invention can be realized in hardware or as software or computer code that can be stored in a machine readable recording medium such as a CD ROM, a RAM, thumbnail drive, a floppy disk, a flash storage, a hard disk, or a magneto-optical disk or downloaded over a network and stored as a non-transitory data on one of the aforementioned mediums, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An electronic apparatus comprising:
a display unit for processing and displaying an image;
a storage unit storing a plurality of files classified by directories;
an input unit receiving input from a user; and
a controller controlling the display of a selected first directory and content of the selected first directory and to display at least one second directory other than the first directory corresponding to exploration in a direction provided by the input unit in accordance with a user selection.

2. The electronic apparatus according to claim 1, wherein the second directory is arranged in one of a same directory level as the first directory or in a different directory level from the first directory.

3. The electronic apparatus according to claim 1, wherein the exploration in the direction provided by the input unit comprises at least one of exploration to a higher directory level of the first directory, exploration to a lower directory level of the first directory and exploration in a directory level of the first directory.

4. The electronic apparatus according to claim 1, wherein the controller controls the display of a first indicator representing a directory level of the first directory.

5. The electronic apparatus according to claim 4, wherein the controller controls the display of a directory level of the second directory in the first indicator.

6. The electronic apparatus according to claim 1, wherein the controller controls the display of a second indicator corresponding to the exploration in the direction provided by the input unit.

7. The electronic apparatus according to claim 1, wherein the controller controls the display of a third indicator corresponding to a transfer to a directory level.

8. The electronic apparatus according to claim 1, wherein the content of the first directory comprises at least one of a lower directory of the first directory and files included in the first directory.

9. The electronic apparatus according to claim 1, wherein the controller controls the display of a first icon corresponding to the first directory and a second icon corresponding to the second directory.

10. The electronic apparatus according to claim 1, wherein the input unit comprises at least one of slide input, touch input and a button for user input.

11. A method of controlling an electronic apparatus comprising:
sorting by a controller and storing in a storage unit a plurality of files by a plurality of directories;
receiving input from an input unit indicating a user selection;
displaying by a display unit a selected first directory and a content of the first directory; and
displaying by the display unit at least one second directory other than the first directory corresponding to exploration in a direction provided by the input unit in accordance with a user selection.

12. The method according to claim 11, wherein the second directory is arranged in one of: a same directory level as the first directory or in a different directory level from the first directory.

13. The method according to claim 11, wherein the exploration in the direction provided by the input unit comprises exploration to a higher directory level of the first directory, exploration to a lower directory level of the first directory and exploration in a current directory level of the first directory.

14. The method according to claim 11, comprising displaying by the display unit a first indicator representing a directory level of the first directory.

15. The method according to claim 14, comprising displaying by the display unit a directory level of the second directory in the first indicator.

16. The method according to claim 11, comprising displaying by the display unit a second indicator corresponding to the exploration in the direction.

17. The method according to claim 11, comprising displaying by the display unit a third indicator corresponding to a transfer to a different directory level.

18. The method according to claim 11, wherein the content of the first directory comprises at least one of a lower directory of the first directory and files included in the first directory.

19. The method according to claim 11, comprising displaying by the display unit an icon corresponding to the first directory and an icon corresponding to the second directory.

20. The method according to claim 11, wherein the input unit comprises at least one of slide input, touch input and button to receive user input.
